(19) United States
(12) Patent Application Publication
(10) Pub. No.: US 2012/0061957 A1
(43) Pub. Date: Mar. 15, 2012

(54) METHOD FOR OPERATING A WIND TURBINE IN A POWER-REDUCED MODE OF OPERATION

(76) Inventors: Guillaume Steinmetz, La Plaine Saint Denis (FR); Joseph Fonio, Levallois-Perret (FR)

(21) Appl. No.: 12/971,980

(22) Filed: Dec. 17, 2010

(30) Foreign Application Priority Data
Dec. 17, 2009 (EP) 09 015 592

(51) Int. Cl. H02P 9/00

(52) U.S. Cl. 290/44

(57) ABSTRACT

A method of operating a wind turbine. A rain sensor and a control unit are configured to control the operation of the wind turbine. The wind turbine has a power-reduced mode of operation and a non-power-reduced mode of operation. In the power-reduced mode of operation a noise emitted by the wind turbine is lower than in the non-power-reduced mode of operation. Precipitation is detected by the rain sensor. A signal representative of the precipitation is generated and transmitted. The signal representative of the precipitation is received by the control unit. One mode of operation is selected from one of the power-reduced mode of operation and the non-power-reduced mode of operation, depending on the signal representative of the precipitation by the control unit. The wind turbine is controlled by the control unit to operate in the selected mode of operation.

### CROSS REFERENCE TO RELATED APPLICATION

This application claims priority to European Patent Application No. EP09015592 filed on Dec. 17, 2009.

### FIELD OF THE INVENTION

The present application relates to a method for operating a wind turbine which may be switched to a power-reduced mode of operation. In the power-reduced mode of operation, the noise emitted by the wind turbine is reduced in order to be able to observe existing noise control regulations, for example.

### BACKGROUND OF THE INVENTION

A wind turbine and a method is disclosed in DE 10 2007 025 314 A1 for avoiding collisions of flying animals with the rotating blades of a rotor of a wind turbine. To avoid collisions, local sound sources which emit a sound spectrum in order to warn flying animals about the moving blades are attached to the rotor blades. It is also disclosed that the emission of sound signals is stopped when a rain sensor detects that precipitation is present.

A method for operating a wind park is disclosed in EP 1 389 682 B1, in which the rotational speed and/or power of the first wind turbine in the wind park is set below its maximum possible rated value. By reducing the power of the first wind turbine in a wind park, it is intended to be sure that the noise control regulations for the level of noise can be observed.

A method for operating a wind park comprising at least two wind turbines is disclosed in EP 1 192 355 B1 in which, depending on the time of day, the rotational speed of at least one of the wind turbines is set such that at a predetermined immission point a predetermined noise level is not exceeded. In addition to the dependency on the time of day, it is disclosed that the wind direction also has to be taken into account. Alternatively, it is also provided to utilize the wind strength, in addition to the wind direction and the time of day, when reducing the power.

With the development of increasingly large wind turbines, the noise emissions thereof are a deciding factor for many locations. It has been established in noise control regulations, for example, that the noise level may not exceed a specific value at certain noise immission points. However, it is also possible that the background noise level which is present at an immission point without the operation of the wind turbine may only be increased by a certain amount by the noise produced by a wind turbine.

These regulations represent a problem for the operation of a wind turbine. Certain wind directions and/or wind speeds may result in exceeding the predetermined values at the immission point. The wind turbine thus has to operate in a noise-reduced mode. Moreover, the level of background noise at the immission point at night is lower than during the day, which means that the wind turbine also has to operate in a noise-reduced mode during the night. In wind turbines, it is known to provide a power-reduced mode of operation which, depending on the time of day, the wind direction and the wind strength, makes it possible to reduce the power of the wind turbine and thus also the noise emissions thereof. A drawback with the known method is that, as a result, the output of the wind turbines is reduced.

### DESCRIPTION OF THE INVENTION

The object herein is to provide a method for operating a wind turbine in a power-reduced mode of operation as well as such a wind turbine which meets existing noise control regulations while minimizing the reduction to the output of the wind turbine too greatly.

The method serves for operating a wind turbine which may be switched to a power-reduced mode of operation in order to reduce the noise emitted by the wind turbine. In addition to the power-reduced mode of operation, the wind turbine may also be operated in a non-power-reduced mode of operation. The method has a step in which a rain sensor detects precipitation. The rain sensor generates a signal which represents the precipitation and transmits said signal to the control unit. The control unit receives the signal and operates the wind turbine in the at least one power-reduced mode of operation or in the non-power-reduced mode of operation, depending on the precipitation detected by the rain sensor. The method is based on the recognition that the sound waves emitted by the wind turbine are partially absorbed by the rain and there is an increased level of noise at the immission point as a result of the precipitation which is present. As a result, it is possible to operate the wind turbine in the non-power-reduced mode in the event of precipitation. Therefore, when observing the noise control regulations it is possible that the wind turbine may also be operated in a non-power-reduced mode of operation. In particular, in regions with frequent precipitation, a considerable increase in output for the wind turbine may be achieved as a result.

In one embodiment, the wind turbine is operated in the at least one power-reduced mode of operation during a predetermined time of day and/or night if no precipitation is detected by the rain sensor. This means that when precipitation is absent the wind turbine switches at a first time of day to the power-reduced mode of operation and at a second time of day stops the power-reduced mode of operation. If precipitation starts between the first and the second time, the wind turbine according to the inventive method does not operate in the power-reduced mode of operation but switches to a non-power-reduced mode of operation whereby a greater production of power is possible.

In one embodiment of the method according to the invention, the rain sensor detects the strength of the precipitation and the wind turbine is operated in the non-power-reduced mode of operation if the detected strength of the precipitation exceeds a predetermined threshold. Such a monitoring of the threshold ensures that with low precipitation, which is possibly not sufficient to suppress noise emissions from the wind turbine, the power-reduced mode is continued. The monitoring of the threshold ensures that the precipitation is sufficiently strong to suppress or drown out the noise emissions of the wind turbine.

In one embodiment, the power-reduced mode of operation comprises at least two different maximum power values. This means that in the power-reduced mode of operation, the wind turbine may be operated at different maximum power levels below the rated power. If the wind turbine is operated, therefore, in the power-reduced mode of operation, one of the possible maximum power values is selected depending on the strength of the precipitation. For the plurality of different maximum power values, depending on the detected strength of the precipitation either the power-reduced mode of operation is stopped and the wind turbine is operated in the non-power-reduced mode of operation or, within the power-reduced mode of operation, switched to a higher maximum power value. This means that with high precipitation which is associated with a high noise level, it is possible for the mode of operation to be switched to the non-power-reduced mode of operation. If, however, precipitation is present which produces a certain noise level but does not yet permit the operation of the wind turbine at rated power, within the power-reduced mode of operation it is possible to switch the mode of operation to a higher maximum power value. If the precipitation is low, a lower maximum power value may be selected within the power-reduced mode of operation.

The object is achieved by a wind turbine comprising a control unit which controls the operation of the wind turbine, the wind turbine having at least one power-reduced mode of operation and a non-power-reduced mode of operation. In the power-reduced mode of operation, the noise emitted by the wind turbine does not exceed a predetermined limit value. A rain sensor is provided which detects precipitation and forwards a signal which represents the precipitation to the control unit. The control unit reacts accordingly to the signal of the rain sensor and operates the wind turbine in the at least one power-reduced mode of operation or in the non-power-reduced mode of operation. The power-reduced mode of operation, in which the wind turbine produces less power than is possible, is avoided when precipitation falls. In this manner, the output of the wind turbine may be increased, without conflicting with noise control regulations.

In one embodiment, the rain sensor is arranged on or at the wind turbine. For example, the rain sensor may be mounted on the nacelle of the wind turbine. It is also possible to arrange a rain sensor at a distance from the site of the wind turbine. This is, for example, of significance if the rain sensor is able to detect the amount of output per unit area.

In one embodiment, the rain sensor compares the amount of precipitation detected with a predetermined threshold and only generates a signal for the control unit of the wind turbine if the amount of precipitation detected exceeds the threshold.

In one embodiment of the wind turbine according to the invention, the power-reduced mode of operation comprises at least two different maximum power values. Depending on the amount of precipitation detected, it is possible to switch between different maximum power values. If the amount of precipitation detected is not sufficient to switch the mode of operation to the non-power-reduced mode of operation i.e. to switch to rated power, this embodiment of the wind turbine permits the wind turbine to be able to be operated at a higher maximum power value.

In one embodiment, the rain sensor detects whether or not precipitation is present. Preferably, the rain sensor is configured as an optical sensor, which generates the control signal for controlling the operation of the wind turbine if precipitation has been detected.

### BRIEF DESCRIPTION OF THE DRAWINGS

Embodiments are now described in more detail hereinafter with reference to an exemplary embodiment. In the drawings:

FIG. 1 shows a wind turbine comprising a rain sensor on the nacelle in a schematic view,

FIG. 2 shows a time curve for the power-reduced mode of operation in the wind turbine, if a power-reduced mode is provided for a specific period during the night and

FIG. 3 shows a time curve of the power-reduced mode for a wind turbine, for which a power-reduced mode is provided.

### DETAILED DESCRIPTION OF THE DRAWINGS

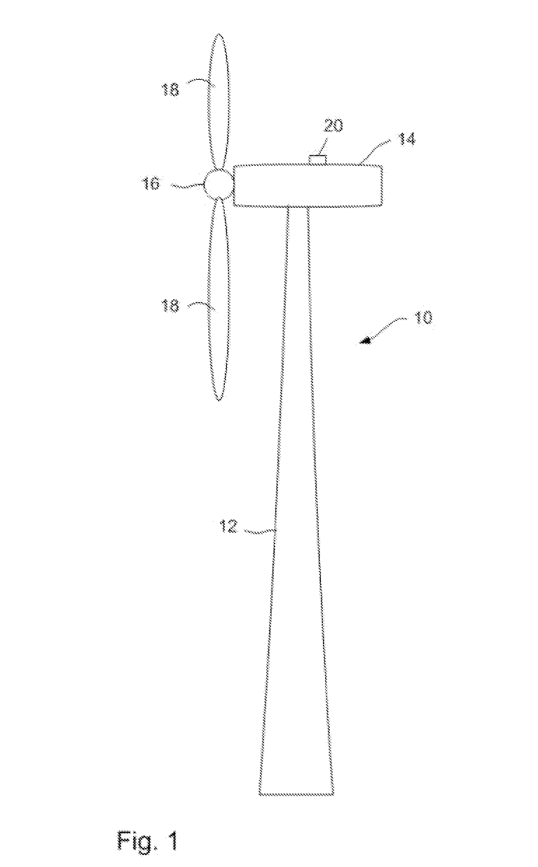

FIG. 1 shows a wind turbine 10 comprising a tower 12 and a nacelle 14. The nacelle 14 bears a rotor 16 comprising rotor blades 18. On the upper face of the nacelle 14, a schematically shown rain sensor 20 is provided which detects whether precipitation in the form of rain, snow or ice is present.

The rain sensor may, for example, be a rain sensor as is conventionally used for motor vehicles. Such sensors operate optically, for example, by detecting the moisture on a pane of glass. To this end, an infrared light beam is directed towards the pane of glass and the reflected light is detected. If condensation has collected on the pane of glass, the infrared light is reflected and the infrared sensor may detect the reflected light. If there is no precipitation, the infrared light is not reflected or only a small proportion is reflected, so that the sensor does not detect any reflected infrared light. Other embodiments of a precipitation sensor are also possible, in particular, precipitation sensors may also be provided which are able to detect the amount of precipitation.

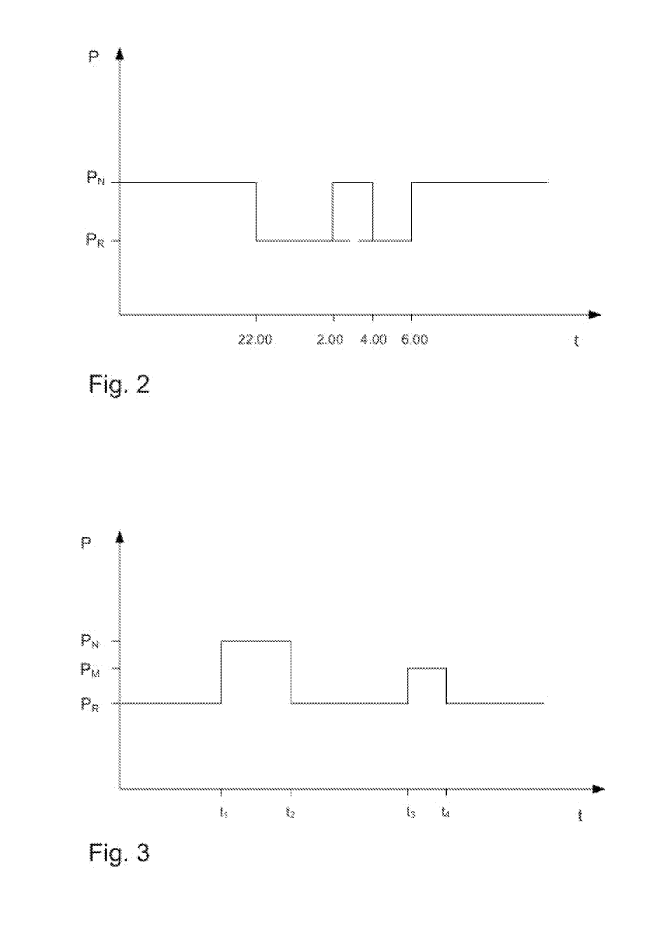

FIG. 2 shows an operation of a wind turbine in which it is predetermined that between 10 pm and 6 am a power-reduced operation has to take place. In normal operation the wind turbine is operated at its rated power P_{N}. If the control unit establishes that 10 pm has been reached, the mode of operation is switched to a power-reduced mode. In the power-reduced mode, the wind turbine is only operated in wind at a maximum power P_{R}, P_{R} being less than P_{N}.

In FIG. 2, at 10 pm the wind turbine switches to the power-reduced mode, in which the maximum power is P_{R}. At 2 am, the wind turbine switches again from the power-reduced mode to the rated power mode where P_{N} is the maximum power. The switching takes place due to the onset of precipitation, so that the rain sensor 20 of the control unit of the wind turbine indicates that a power-reduced mode is no longer necessary. Towards 4 am, the rain eases and the rain sensor 20 indicates to the control unit of the wind turbine that no precipitation is present. In this case, the wind turbine again switches to the power-reduced mode, in order to switch again at 6 am to the rated power mode. In the exemplary embodiment shown in FIG. 2, it is provided for the wind turbine that, due to noise control regulations in the time period from 10 pm to 6 am, said wind turbine has to observe specific emission limit values. As a result of precipitation from 2 am to 4 am, the noise emissions of the wind turbine are masked so that even when operated at rated power, the predetermined emission values of the wind turbine may be maintained.

FIG. 3 shows the time curve of the power of a wind turbine which, during the time period shown in FIG. 3, is operated in a power-reduced mode at maximum power P_{R}. Such a power-reduced mode may, for example, result from the wind direction. Depending on the intensity of the precipitation, the wind turbine may switch to a power-reduced mode at medium power P_{M} or to a mode at rated power P_{N}. In the example of FIG. 3, the rain sensor 20 at the time t₁ indicates that very high precipitation is present. The wind turbine switches to rated power mode. At the time t₂, the rain sensor 20 indicates that precipitation is no longer present and the wind turbine switches to power-reduced mode. At the time t₃, light rain falls. The wind turbine increases its power to the value P_{M}. At the time t₄, the rain sensor 20 indicates that precipitation is no longer present and the wind turbine again switches to the power-reduced mode. As a result, the power output of the wind turbine may be improved and the noise control regulations observed. In the above exemplary embodiment, in which two maximum power values are provided for the power-reduced mode of operation, in principle more than two maximum power values may be provided. In this case, according to the amount of precipitation detected, the wind turbine switches to the corresponding maximum power value. The greater the amount of precipitation, the greater the maximum power value for the power-reduced mode of operation may be. In principle, it is also conceivable to provide continuous maximum power values for the power-reduced mode of operation, such that in the absence of precipitation or an amount of precipitation below a first threshold the maximum power of the wind turbine is reduced and subsequently, in proportion to the amount of precipitation, a maximum power value for the wind turbine is determined up to a second threshold for the amount of precipitation from which the wind turbine may then be operated at rated power.

The preceding may be used particularly advantageously, in particular, for noise control regulations which are based on relative noise pollution, such as for example regulations which specify that the noise emitted by the wind turbine may only be a predetermined value above the ambient noise. If the noise control regulations, for example, prescribe that during the night the ambient noise may only be exceeded by 3 dB, it may be ensured that the onset of rain masks the previously emitted noise of the wind turbine and, in spite of the rated power, the limit of 3 dB is not exceeded.

What is claimed is:

1. A method of operating a wind turbine comprising a rain sensor and a control unit configured to control the operation of the wind turbine, wherein the wind turbine has a power-reduced mode of operation and a non-power-reduced mode of operation, wherein in the power-reduced mode of operation a noise emitted by the wind turbine is lower than in the non-power-reduced mode of operation, the method compromising:
detecting precipitation by the rain sensor;
generating and transmitting a signal representative of the precipitation;
receiving the signal representative of the precipitation by the control unit;
selecting one of the power-reduced mode of operation and the non-power-reduced mode of operation, depending on the signal representative of the precipitation by the control unit; and
controlling the wind turbine by the control unit to operate in the selected mode of operation.

2. The method of claim 1, wherein the wind turbine is controlled to operate in the power-reduced mode of operation during a predetermined time of day and/or night if the signal representative of the precipitation represents no precipitation.

3. The method of claim I, wherein a strength of the precipitation is detected by the rain sensor, a signal representative of the strength of the precipitation is generated and transmitted and the signal is received by the control unit, wherein the control unit controls the wind turbine to operate in the non-power-reduced mode of operation if the detected strength of the precipitation exceeds a predetermined threshold.

4. The method of claim 3, wherein the power-reduced mode of operation comprises at least two different power values and if the power-reduced mode of operation is selected one power value is selected depending on the strength of the precipitation and the wind turbine is controlled to operate in the selected mode of operation with the selected power value.

5. The method of claim 1, wherein a strength of the precipitation is detected by the rain sensor, a signal representative of the strength of the precipitation is generated and transmitted and the signal is received by the control unit, wherein the control unit controls the wind turbine to switch from the power-reduced mode of operation to the non-power-reduced mode of operation and to operate in the non-power-reduced mode of operation depending on the strength of the precipitation.

6. A wind turbine comprising: a control unit configured to control operation of the wind turbine, wherein the wind turbine has a power-reduced mode of operation and a non-power-reduced mode of operation, wherein in the power-reduced mode of operation a noise emitted by the wind turbine does not exceed a predetermined threshold, the wind turbine further comprising a rain sensor configured to detect precipitation, to generate and transmit to the control unit a signal representative of the precipitation, wherein the control unit is configured to receive the signal representative of the precipitation, to select one mode of operation from one of the power-reduced mode of operation and the non-power-reduced mode of operation, and to control the wind turbine to operate in the selected mode of operation depending on the signal representative of the precipitation.

7. The wind turbine of claim 6, wherein the rain sensor is arranged on or at the wind turbine.

8. The wind turbine of claim 6, wherein the rain sensor is arranged at a distance from the site of the wind turbine.

9. The wind turbine of claim 6, wherein the rain sensor is configured to detect a precipitation per unit area.

10. The wind turbine of claim 9, wherein the rain sensor is configured to compare an amount of precipitation detected with a predetermined threshold and to generate and transmit a signal to the control unit if the amount of precipitation detected exceeds the predetermined threshold.

11. The wind turbine of claim 10, wherein the power-reduced mode of operation comprises at least two different maximum power values (P_{M}, P_{R}) and further wherein the control unit is configured to select one of the maximum power values depending on the amount of precipitation detected.

12. The wind turbine of claim 6, wherein the rain sensor is configured to detect whether or not a precipitation is present.
